(19) United States
(12) Patent Application Publication
(10) Pub. No.: US 2008/0109910 A1
(43) Pub. Date: May 8, 2008

(54) Content borrowing system and method

(76) Inventors: Neil Day, Mountain View, CA (US); Frank Ramirez, San Jose, CA (US); Igor Cherny, Redwood City, CA (US)

Correspondence Address: DLA PIPER US LLP, 2000 UNIVERSITY AVENUE, E. PALO ALTO, CA, 94303-2248, US

(21) Appl. No.: 11/594,511

(22) Filed: Nov. 7, 2006

(51) Int. Cl. G06F 21/22

(52) U.S. Cl. 726/27

(57) ABSTRACT

A content borrowing system and method is provided in which pieces of content can be shared by one or more borrowers using parallel sharing, serial sharing or strict serial sharing.

### FIELD OF THE INVENTION

The invention relates generally to a system and method for permitting one or more users to borrow pieces of content from each other.

### BACKGROUND OF THE INVENTION

Typical file sharing services and systems such as Morpheus or Napster were unsuccessful because they did not adequately control the sharing of content that occurred using their system and were subject to copyright lawsuits accusing them of illegal copying of the content. It is desirable to provide a system and method by which users can borrow content without being subjected to legal prosecution for copyright theft.

### BRIEF DESCRIPTION OF THE DRAWINGS

FIG. 1 illustrates an example of an web-based implementation of a borrowing system;

FIG. 2 illustrates an example of a method for borrowing content using the borrowing system;

FIG. 3 illustrates a set of entities that participate in the borrowing method shown in FIG. 2; and

FIG. 4 illustrates more details of a license management method.

### DETAILED DESCRIPTION OF AN EMBODIMENT

The system is particularly applicable to a web-based, software client/server implementation of a borrowing system and it is in this context that the invention will be described. It will be appreciated, however, that the system and method has greater utility since the borrowing system and the borrowing methods can be implemented using other architectures, using hardware based systems, using combination hardware and software systems, using other links than those described below, etc. so that the borrowing system and method are not limited to the particular implementation of the embodiment described below.

The borrowing system and method permits one or more users to borrow each other's collection(s) of content or pieces of media (referred to as content herein below). The content borrowed using the system may include any piece of digital content including music, video files, writings, articles, books and the like. The content may also be a collection of related pieces of sub-content wherein the borrowing may occur at the content level and/or at the sub-content level. For example, with music, the content may be albums and the sub-content may be one or more tracks/songs on each album and the borrowing may be of the album and/or of one or more tracks that are part of the album. In one exemplary embodiment, the content may be music. The borrowing system and method may be owner centric since the owner so that owners have priority over borrowers when accessing their collection, and should be able to set preferences to restrict borrowing while they are actively using the content collection. The borrowing system may provide a “set and forget” operation in which once the owner grants permission or invites someone to their collection, the system executes their desired permissions and admissions without any intervention. The system may also make it easy for the owner of content to modify or cancel settings and also make it easy for the user to determine who is borrowing the content from the owner generally or at any particular time. The borrowing system may operate on an invitation only wherein the owner must explicitly invite a person to borrow content with no solicitation. The borrowing system may also have a default permission setting in which the owner shared his/her content with friends of the owner wherein the owner specifically identifies the friends of the owner.

In one exemplary embodiment of the borrowing system, the system allows a user to share their music collection with a group of friends to whom they have sent explicit invitations. The lender has control over the visibility and sharing status of each item in his/her collection. The invitations are sent to friends by the system and give each invitee access to the lender's collection (partially or in full) according to preset permissions, but the invitations may optionally suggest one or more pieces of media/content to a particular invitee. For example, the owner might send his/her friend Bob, who's into bluegrass, an invitation to check out the latest Sam Bush release and his/her David Grisman back catalog. The borrowing system may also permit the owner to set up groups of content, playlists and coarse grained categories, such as a “binder” of music and then permit no one, everyone, friends and/or family to borrow that binder/group.

The borrowing system may also have one or more different strategies for handling the situation when more than one borrower wants to borrow a particular piece of content/media at the same time. The strategies may include parallel borrowing, serial borrowing and strict serial borrowing.

Parallel Borrowing

Once an invitation to share has been sent to a group of potential borrowers, up to a predetermined number, such as 10, can “check out” an item for a certain period of time or number of plays. Once the check out limit has been exceeded, additional requests are added to a queue. As soon as a one of the “check outs” is returned to the lender, a certain number of people in the queue, such as 5, are notified that they are eligible to borrow an item, and then, as soon as all the “check outs” are claimed the other people are returned to the queue and so forth.

For parallel borrowing, if two people are playing an album and two listeners happen to “Collide” in that both want to listen to the same song on the album, the borrower who checked out the album later in time may be paused until the first user releases the song and then the playback of the song for the borrower continues. Alternatively, the system may skip over tracks that are in use by another borrower and then return to play those tracks after the tracks have been released by the prior borrower.

Serial Borrowing

Once an invitation to share has been sent to a group of potential borrowers, the first one to accept can “check out” an item for a certain period of time or number of plays, and at the end of the loan the item is returned to the lender's collection. If multiple people have requested to borrow an item, the first requester will be granted permission and subsequent prospective borrowers will be added to a queue. As soon as the borrower returns it, notification will be sent to up to a predetermined number queued prospective borrowers, such as ten prospective borrowers. As soon as one of the prospective borrowers accepts the loan, the other prospective borrowers are returned to the queue. The difference from parallel borrowing is the number of “Check outs” that need to be managed simultaneously.

Strict Serial Borrowing

In this method, once the piece of content is loaned by a borrower, it is not available to be used by anyone else (including the owner), until the piece of content is released by the borrower. This method simplifies the conflict management of the system and works very much like borrowing books from a library. If the library has multiple copies, multiple people can check them out. The one difference is you can't read the same sentence as someone else is reading it. Now, an example of a web-based implementation of the borrowing system is described.

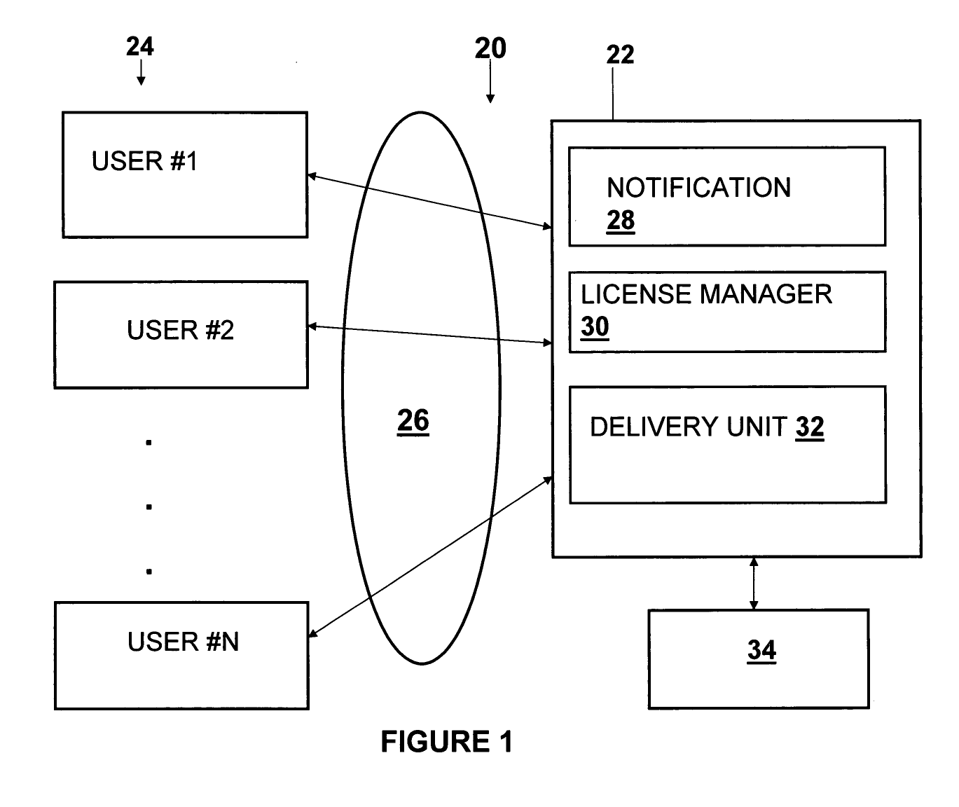

FIG. 1 illustrates an example of an web-based implementation of a borrowing system 20. The borrowing system 20 may include a borrowing unit 22, that may be in this example one or more server computer(s) with a processing unit, etc, that execute one or more pieces of software code in order to implement the functions and methods of the borrowing system. However, the borrowing unit may be implemented in other manners that are within the scope of the invention. The borrowing unit may manage the borrowing of content between a set of users 24. The users may be either an owner of a piece of content, a borrower of a piece of content or both. Each user may use a computing device to connect over a link 26 to the borrowing unit 22. The computing device may be any device with sufficient processing power, memory and connectivity to be capable of connecting with and interacting with the borrowing unit, such as a personal computer, a laptop computer, a PDA, a portable music device, a mobile phone, a wireless email device and the like. In one example, each user may use a personal computer, the link 26 may be the Internet or World Wide Web and the protocol uses to establish a session and exchange with the borrowing unit may be the well known hypertext transfer protocol (HTTP) or secure HTTP. In the example in FIG. 1, the borrowing unit 22 is located separate from each users. However, a borrowing unit 22 may also be associated with each computing device for each user so that the system has a plurality of borrowing units (in a peer-to-peer architecture) wherein each borrowing unit may control the borrowing of the content and sub-content on each computing device. The borrowing unit 22 may include one or more sub-units that carry out particular operations of the borrowing unit. In one embodiment, the sub-units are implemented as one or more pieces of software (containing a plurality of lines of computer code) that are executed by the borrowing unit. The sub-units may include a notification unit 28, a license manager unit 30 and a delivery unit 32 wherein the notification performs notification of the prospective borrowers and notifies the owner of the current borrowers for each piece of content, the license manager controls the borrowing of each piece of content and may implement the parallel borrowing, serial borrowing or strict serial borrowing methods described below and the delivery unit delivers the pieces of content to each user when the user borrows the content.

In the music content example, the borrowing system may treat tracks, albums and playlists as unique entities, while preserving the underlying rule that no track can be accessed simultaneously. For instance, someone should be able to borrow the album “AC/DC: Back in Black” and another person should be able to check out “You Shook Me All Night Long” (which is a song/track that is part of the “AC/DC: Back in Black” album) without tripping over the maximum borrower limits. In other words, the borrowing limitations are placed on each song/track, but not on each album or playlist since these entities have more than one song/track. The borrowing system may also keep a record of each borrower that has borrowed a piece of media and “Lock Out” repeated borrowing of the same media from the same friends by the same borrower since repeat borrowing inflates the number of shares that could happen on a particular track which should be prevented. For example, the number of “repeat borrows” for each borrower is configurable, but there is a maximum number of repeat borrows. To keep these records, the borrowing system may store a history of borrowing for each piece of media/content that may be stored in the storage unit 34.

In the case when a conflict occurs between two potential borrowers requesting a piece of media item, immediately upon the release of the item by the first borrower, the second borrower will have access to the piece of media item. For example, if the owner of the item tries to play it while a borrower is currently playing it, the lender will be notified that the item is in use and to try to play it again at an estimated time. Once the lock has expired, the owner will be able to claim the media.

If the owner of an item wishes to reclaim their music, they can “Block” the person who is currently borrowing the item. The blocking action does not change the duration of the loan. However, once the owner has decided to retrieve the item, they hold on to it for the duration of their session with a predetermined time period, and after the session expires it is available to the borrower again. The user interface should allow the owner to temporarily disable sharing for the duration of their session, or specifically block a track, album or playlist. The action to block a track, album and/or playlist should not interrupt the song that is currently playing on the system of the borrower, but the block takes effect once the borrower has completed listening to the currently playing song.

The system may also provide really simple syndication (RSS) feeds for the most popular borrowed items, the favorites of an owner/borrower, the items currently being listened to by the users, the newest collections in the system, a wish list for the users and/or comments. The system may also provide personal radio that adheres to the DMCA internet radio rules that permit music to be added to blogs, slideshows and the like. The system may also permit each user to create a personal profile page that may includes links to other sites, such as blogs, flikr, etc. The system may also provide an owner with a visual identification that allows the owner to see what part of the collection is being currently borrowed and by which user so that the owner can monitor the user of his/her items. The system may also provide each owner with a global stats page that includes sharing information. For each borrower, the system may provide a mechanism to view and manage items requested for borrowing by the user.

The system may also permit an owner to determine which friends have joined as user of the system, by the press of a button, by comparing the address book of the owner to the list of users of the system so that the owner can add a user (who is not yet listed as a friend) into his/her friend list. The system may also, when authorized by a user, scan the address book of the user and then send out invitations to those people in the address book that are not users of the system. The system may also provide the ability for an owner to remove a user from their friends list. Now, a method for borrowing content that may be implemented on the above system shown in FIG. 1 or implemented on other systems will be described in more detail.

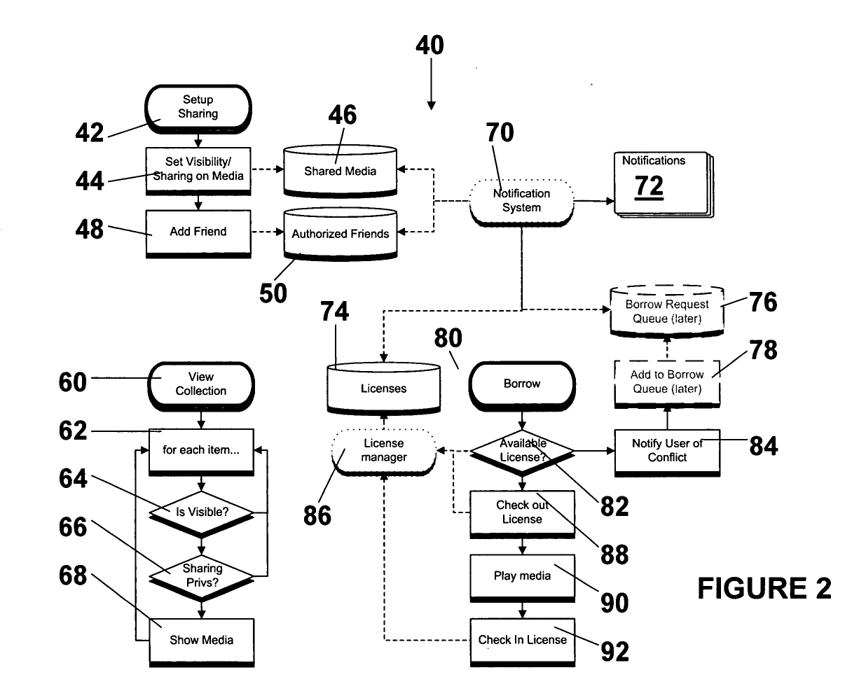

FIG. 2 illustrates an example of a method 40 for borrowing content using the borrowing system. In one embodiment, the method may be implemented as one or more lines of software code wherein the lines of computer code are executed by a processing unit, such as is contained in the borrowing unit 22 shown in FIG. 1, to perform the operations and actions described below. The method may include setup sharing 42 in which one or more actions may be taken including optionally setting visibility/sharing status for each item of the owner 44 and/or adding a potential borrower (friend) 48 to the system so that the borrower can borrow items from the owner. The owner of one or more pieces of content (songs in the music example) may load the one or more pieces content (items) into the system (and form a collection of items) so that each item may be borrowed using the borrowing system. The owner may optionally, for each item, set a visibility setting and/or a sharing status wherein a visible setting means that the particular item is available for borrowing and a not visible setting means that the particular item is not available for sharing until the visibility status is changed. The sharing process will indicate each item's sharing status with a particular user or group of users. The visibility and sharing settings for each item may be stored in a shared media record 46 and the authorized users for the owner are stored in an authorized friends record 50. The method may also permit the owner to specify a “binder” of items wherein the items are borrowed as a unit and each binder may therefore have a visibility setting and a sharing setting and the authorized borrowers for the binder can be specified.

The method may also include the ability to view a collection 60 of the owner. For each item (62), the visibility and sharing settings for the item (64, 66) is shown to the owner who can also view each item in his/her collection (68).

Once the collection is part of the system and the authorized borrowers are identified, a notification system 70 may store data about a loan in the shared media record 46 and the authorized borrowers record 50 and generate a loan/borrow notification for an item 72. The notifications can be send via various mediums and methods, such as via an email message, via a flash interface or via an HTML interface/web page for example, although the borrowing method is not limited to the notification mediums and methods described herein and can use any other mediums and methods. The method may also generate notifications for a new collection to be borrowed, notifications for a specific one or more items to be borrowed/shared and/or notification of when a particular item will be available to the borrower from the queue for that item. The notification system generates these notifications at least in part from a licenses record 74 that stores information about each particular item and the license associated with each particular item and stores information in the licenses record 74 about the borrows for each borrower that may be used to control the user of each item.

The method may insert a request of a borrower to borrow a particular item into a queue record 76 that contains the borrowing queues associated with each item. The method may then add a borrower to the queue (for a particular item) (78) if the item is not immediately available. The method may include a borrow operation 80 wherein a potential borrower asks to borrow an item. The method checks to see if the item is available to borrow (82) and, if the item is not immediately available, notifies the potential borrower of the conflict (84) and adds the potential borrower to the queue for that item. If the item is available to borrow, the identification of the borrower and the identifier of the item are passed onto a license manager 86 and the license is checked out (88), the item is played (90) and, once the item has been played, the license for the item in checked back in (92) and the check-in is communicated to the license manager 86. The method may also permit the potential borrower to skip over a checked out/unavailable item or a special case rewind during which a second check out does not occur. In the special rewind case, a user wants to restart playing the song to which they are already listening and the user should not get penalized for rewinding a song. When the potential borrower waits for an item to become available, the method can add his/her request to the queue for the item (described above), but may also provide the potential borrower with any availability information about the item such as how long the item is anticipated to be unavailable.

The method may also permit the owner to view one or more collections or one or more recommendations of a friend (assuming that the owner has a proper authorizations). The collections or suggestions may be viewed from the notifications provided by the notification system or may be displayed in a sharing user interface. The method may also permit an owner to block one or more items (typically while the owner is logged into the system) from being borrowed or block all items of the owner from being borrowed during a particular time period.

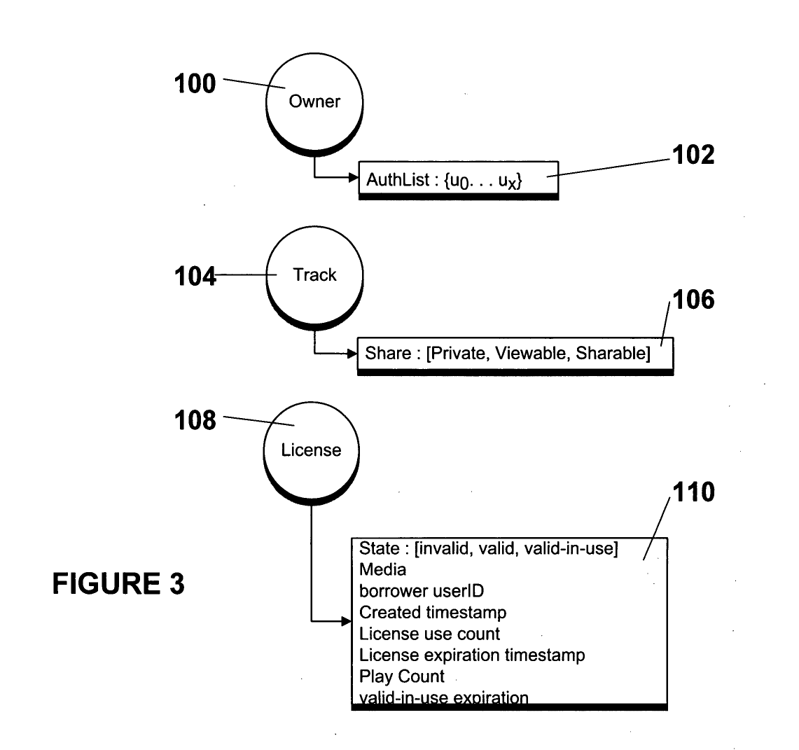

FIG. 3 illustrates a set of entities that participate in the borrowing method shown in FIG. 2. The entities shown in FIG. 3 are for the same music example, although the system and method may be used for other pieces of content for which the entities shown in FIG. 3 would need to be adjusted in a known manner for the particular type of content. In the music example, the system and method has an owner data structure 100 wherein the data structure includes a list 102 of the authorized borrowers who can view the items for the particular owner and a track data structure 104 that includes a sharing privileges list 106 wherein each track may be private (not borrowable), viewable (viewable by users but not sharable/borrowable) or may be sharable (viewable and sharable/borrowable) by authorized users of the system. For example, a collection of a owner may be viewable so that the owner may publish the collection on a blog, home page or other location so that non-users of the borrowing system can see the collection of the owner.

The system and method may also have a license data structure 108 that has one or more pieces of information 110 and binds an owner to an item, and manages the amount of time the particular item may be borrowed. Once a license is created in the system, it remains in the system to allow the system to control repeated borrowing as described above. As shown, each license may include a state field (with a status of invalid, valid or valid-in-use), a media item identifier, a borrower userID, a created timestamp, a license use count field, a license expiration timestamp, a play count and a valid-in-use expiration field.

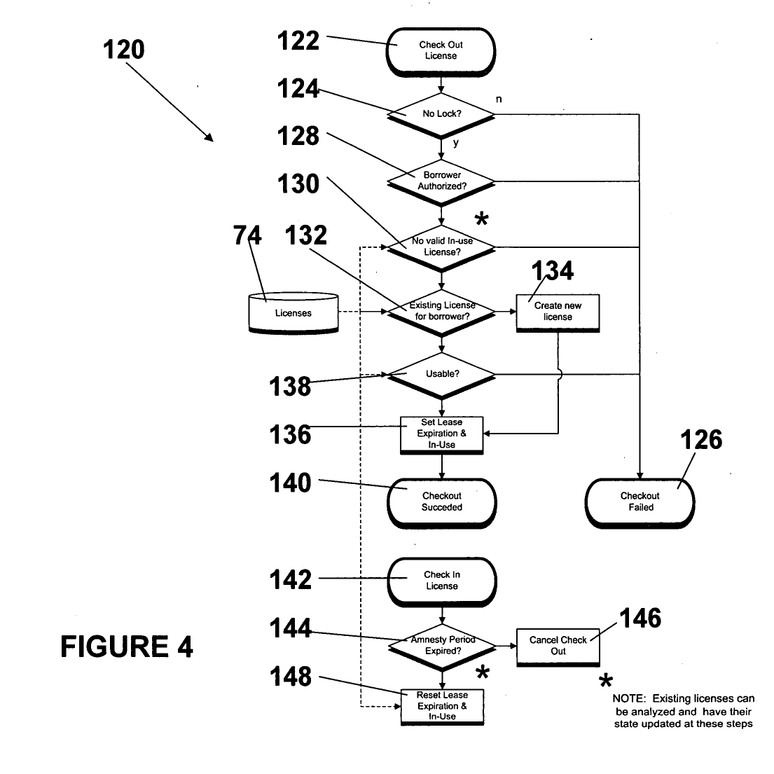

FIG. 4 illustrates more details of a license management method 120 that occurs when each item is requested to be borrowed by a particular potential borrower. The license manager takes care of determining if a license is available for a given piece of media for a given user. As shown in FIG. 3, the license can have four states including: Non-existent, valid, valid-in-use and invalid. In the license method, an item (a piece of media) may be played unless there is a license in either valid-in-use or invalid states that is associated with the item. When a particular item is claimed, the borrower's license is set to valid-in-use and the “valid-in-use expiration” time is set. Then, the particular item can be released by explicitly “Checking in” the item or by the “valid-in-use expiration” time elapsing.

Returning to FIG. 4, a potential borrower may request to check out an item that requires the license for the particular item to be checked (122). The license manager then performs a plurality of checks to determine if the item is available for borrowing. An example of these checks is shown in FIG. 4, but the method is not limited to performing all of the particular checks shown in FIG. 4 nor that the check have to be performed in the order shown in FIG. 4. Thus, the license manager, in response to a request to borrow a particular item, checks to see if the item has been locked by the owner (124) and goes into a checkout failed state 126 if the particular item is not available for borrowing. If the item is not locked, the license manager also checks to determine if the potential borrower is authorized to borrow the particular item (128) and that there is not an existing “valid in-use” license for the item (130) and the checkout fails if the user is not authorized or there is a “valid in-use” license for the item. If the item user is authorized and there is no “valid in-use” license for the item, then the method checks to determine if there is an existing license for the borrower (132) by polling the licenses record 74. If there is not an existing license for the borrower of the item, the method creates a new license (134) and then sets the borrowing time period (lease expiration) and the in-use flag for the item (136). If there is an existing license for the borrower, the method determines of that license is usable (138) and, if the existing license is usable, sets up borrowing time period (lease expiration) and the in-use flag for the item (136). The method then indicates that the checkout for the particular item to the particular borrower was successful (140).

When the borrower of an item checks in the item (142) (to return the item), the method determines if the amnesty period expired (144) wherein the amnesty period is a short, system defined interval during which a borrower can sample a song before the borrower triggers one of the three plays for that song or the start of the borrowing period. The method then checks out (146) the item if the amnesty period has expired. If the amnesty period has not expired, the lease expiration for the item is reset and the in-use flag is maintained (148).

The license manager may provide one or more notifications to users of the system. For example, the license manager may notify the users that the particular item (or collection or binder) is being used by the owner, that a particular potential borrower is not longer authorized to borrow from a particular collection of the owner or that the particular item (or collection or binder) is no longer available for borrowing. The license manager may also notify a potential borrower that a particular item is in use and that the potential borrower can check again in a predetermined amount of time or that too many users are borrowing an album (containing the requested item) and the user should check again after a predetermined amount of time. The check back time may be, for example, the time that the current borrower is expected to finish listening to the song which may be the checkout time plus the duration of the song plus some transition time. Thus, the check back time varies depending on the length of each particular song. The license manager may also notify the potential borrower that she/he has already listened to the particular album (with the requested item) a predetermined number of times over a predetermined number of days and will not be permitted to check out the particular album for some period of time. The license manager may also notify a borrower that he/she did not use up a borrow for the item since the borrower did not listen to the item for a sufficient period of time. This means that a user who listens to a song for a short time, such as less than the amnesty period, should not be charged with a check out of that song which allows users to sample a song without actually checking it out.

While the foregoing has been with reference to a particular embodiment of the invention, it will be appreciated by those skilled in the art that changes in this embodiment may be made without departing from the principles and spirit of the invention, the scope of which is defined by the appended claims.

1. A content borrowing system, comprising:
a borrowing unit;
one or more computing devices wherein each device is capable of establishing a connection with the borrowing unit; and
wherein the borrowing unit further comprises a licensing management unit that allows the one or more computing devices to borrow one or more pieces of content with other users of the content borrowing system.

2. The system of claim 1, wherein each piece of content further comprises one or more sub-content items.

3. The system of claim 2, wherein each piece of content further comprises an album and each sub-content item further comprises a track on the album.

4. The system of claim 2, wherein the licensing management unit uses a parallel borrowing strategy in which one or more computing devices borrow a particular piece of content over a period of time.

5. The system of claim 4, wherein the parallel borrowing strategy further comprises a collision strategy when the one or more computing devices request the same sub-content item on the particular piece of content.

6. The system of claim 2, wherein the licensing management unit uses a serial borrowing strategy in which a first computing device checks out a particular piece of content and one or more other computing devices are queued for the particular piece of content.

7. The system of claim 6, wherein the licensing management unit uses a strict serial borrowing strategy in which only a single computing device can check out the particular piece of content.

8. The system of claim 1, wherein the computing devices further comprises one or more of a personal computer, a portable music device, a mobile phone and a handheld computing device having a processor and memory.

9. The system of claim 8, wherein the borrowing unit further comprises a server computer.

10. The system of claim 1 further comprising a plurality of borrowing units resident on each computing device that controls the borrowing of the pieces of content resident on each computing device.

11. The system of claim 1, wherein the content further comprises one or more of music, audio, video, manuscripts, articles.

12. A method for borrowing content using a borrowing unit and one or more computing devices wherein each device is capable of establishing a connection with the borrowing unit, the method comprising:
providing one or more pieces of content;
borrowing, by each computing device, a piece of content from the borrowing unit; and
performing license management for the borrowed piece of content so that a copyright of the piece of content is not violated.

13. The method of claim 12, wherein each piece of content further comprises one or more sub-content items.

14. The method of claim 13, wherein each sub-content item is a track on a particular album.

15. The method of claim 12, wherein the borrowing further comprises a parallel borrowing strategy in which one or more computing devices borrow a particular piece of content over a period of time.

16. The method of claim 15, wherein the parallel borrowing strategy further comprises preventing more than one computing device from listening to the same sub-content item at the same time.

17. The method of claim 12, wherein the borrowing further comprises checking out a particular piece of content by a first computing device and queuing other computing devices that requested the particular piece of content until the first computing device finishes with using the particular piece of content.

18. The method of claim 12, wherein the borrowing further comprises a strict serial borrowing strategy in which only a single computing device can check out a particular piece of content.
